(19) United States
(12) Patent Application Publication
(10) Pub. No.: US 2012/0110433 A1
(43) Pub. Date: May 3, 2012

(54) PARALLEL WEB PAGE PROCESSING

(75) Inventors: Aimin Pan, Beijing (CN); Bin Benjamin Zhu, Edina, MN (US); Kaimin Zhang, Hefei (CN); Lu Wang, Tianjin (CN)

(73) Assignee: Microsoft Corporation, Redmond, WA (US)

(21) Appl. No.: 12/914,638

(22) Filed: Oct. 28, 2010

(51) Int. Cl. G06F 17/20

(52) U.S. Cl. 715/234

(57) ABSTRACT

Methods and systems for parallel Web page processing are usable to parallelize Web page document parsing, Web page layout calculations, Web page style formatting, and Web page script engine processing. Such parallelized parsers may be used to enhance Web page processing and exploit multi-core and multi-processor computing device resources. The parallelized script engine may be used to enhance Web page processing when independent scripting events exist in the Web page document. Additionally, the parallelized layout calculations and style formatting may be used to further enhance Web page processing by allowing multi-core and multi-processor computing devices to take advantage of their parallel processing abilities.

### BACKGROUND

The World Wide Web (Web) has been ever growing and rapidly expanding since its inception. Additionally, since the widespread household use of personal computers, the Web has gained popularity among consumers and casual users alike. Thus, it is no surprise that the Web has become an enormous repository of data, and a platform for various kinds of interactive resources. For example, many interactive applications are now available over the Web. These Web applications may interact with users much like desktop applications, providing rich functionality and full interaction.

Over time, advances in network technology and hardware infrastructures have significantly increased network speed and decreased overall Internet download times. Additionally, with the advent of multi-core processors, computing devices have become extremely fast and efficient at processing digital content. In many cases, however, a bottleneck may occur at the computing device because Web pages are mainly processed in a single thread manner such that only a single core in a processor is used. Unfortunately, adequate tools do not exist for parsing Web page files or processing script language code with multiple processors. Thus, the processing power of multi-core processor computing devices is being wasted. For example, existing Web browsers utilize Web content parsers and script engines that can only operate using a single core in a processor.

### BRIEF SUMMARY

This summary is provided to introduce simplified concepts for parallel Web page processing, which is further described below in the Detailed Description. This summary is not intended to identify essential features of the claimed subject matter, nor is it intended for use in determining the scope of the claimed subject matter. Generally, the parallel Web page processing described herein involves using one or more threads or processes to process Web pages.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a block diagram of an illustrative system for parallel Web page processing.

FIG. 2 is a block diagram illustrating details of parallel Web content parsing for use in parallel Web page processing.

FIG. 3 is a block diagram illustrating details of parallel script engine execution for use in parallel Web page processing.

FIG. 4 is a block diagram illustrating details of parallel style formatting for use in parallel Web page processing.

FIG. 5 is a block diagram illustrating details of parallel layout calculating for use in parallel Web page proc3essing.

FIGS. 6A-6C are diagrams illustrating three examples for determining dependencies while calculating layouts as described in FIG. 5.

FIGS. 7-9 are flowcharts illustrating details of a parallel Web page processing method.

FIG. 10 is a block diagram of a computer environment showing an illustrative system in which parallel Web page processing can be implemented.

### DETAILED DESCRIPTION

### Overview

This disclosure describes parallel Web page processing. In particular, systems and methods are presented for receiving a Web page file associated with a requested URL (Uniform Resource Locator), parsing the Web page file in parallel, utilizing a script engine in parallel for executing script code found within the Web page file, formatting styles in parallel, calculating layouts in parallel, and rendering the Web page content on a display device. Alternatively, the systems and methods may be configured to process a Web page file with any combination of parallel and/or sequential processing: e.g., where some stages are processed in parallel and other stages are processed sequentially. In one instance, the systems and methods may be configured to parse the Web page file in parallel without using parallel processing in the script engine, style formatting, and/or layout calculations. In another instance, the systems and methods may be configured to execute the script engine and style formatting in parallel while parsing the Web page file and calculating layouts sequentially. Additionally, any combination of parallel and/or sequential processing Parallel processing can be executed with multiple threads and/or multiple processes. Additionally, other stages of Web page processing, such as, but not limited to, DOM tree building or rendering may potentially be performed in parallel as well, and may work together with the parallel processing methods described in this disclosure.

In one aspect, parallel Web page processing methods may be configured to receive a Web page file that includes various tags, such as HTML tags, from a location in memory or a Web server located on a network. Tags may be used in a Web page file to indicate starting and ending positions of Web elements. Additionally, a Web browser may parse a Web page into tagged elements in parallel, execute scripts in response to mutually independent scripting events in parallel, format styles in parallel, calculate layouts in parallel, and render the contents of the Web page file on a display device based on a document object model (DOM) tree. In this context, parsing a Web page into tagged elements may include fragmenting the page file based on a tag's property and iteratively assigning fragments to different threads to evaluate the contents of fragments until each fragment is processed. The Web browser may also construct a DOM tree and then modify the DOM tree with scripts executed.

In another aspect, parallel Web page processing may be effectuated by receiving a Web page file that includes tagged elements, fragmenting the tags, parsing the fragmented tags in parallel, and rendering the contents on a display device. The parsing may be effectuated by a Web browser, for example, by iteratively serving each tag to an available thread until each tag has been parsed. The Web browser may identify DOM nodes, scripting language code, or invalid tag fragments. Additionally, the invalid fragments may be merged to other fragments to form valid fragments, and the Web browser may construct a DOM tree based on the identified DOM nodes.

In yet another aspect, a parallel Web page processing system may be configured to receive Web page files that include tags, identify script code and scripting events, execute a set of scripts in responding to dependent scripting events sequentially, and execute sets of scripts in responding to mutually independent sets of scripting events in parallel. In Web pages, scripts may be driven by various events. In some instances, scripts may respond to scripting events such as timeouts, mouse events, keyboard events, and/or Asynchronous Javascript™ Extensible Hypertext Markup Language (AJAX) callback events. In some instances, scripts are embedded in a Web page. In other instances, scripts are dynamically downloaded. In yet other instances, some scripts are embedded in a Web page, other scripts are dynamically downloaded. Additionally, the system may be configured to build a DOM tree based at least in part on the executed scripts and to render the contents of the Web page file on a display device based at least in part on the DOM tree. Scripts in response to mutually independent events may be executed in parallel. In some instances, when a script is detected to be driven by a scripting event that depends on another event, the script may be dispatched to the same thread or process that runs the script driven by the event that is depended on by the current script's event. In other instances, when a script is detected to be driven by a scripting event that is independent of other occurred events, the script may be dispatched to a new thread or process to run in parallel with other scripts. A script and the scripts driven by the events that depend on its scripting event may be run as a transaction. Additionally, the system may be configured to determine whether each executed transaction is valid. In some instances, the system may also be configured to abandon the result of an invalid transaction. In other instances, the system may be configured to re-execute the scripts of a transaction which is determined to be invalid.

In another aspect, a parallel Web page processing system may be configured to receive a Web page and a Cascade Style Sheet (CSS), parse the Web page, generate a DOM to represent the structure of the Web page, and partition CSS rules into subsets. In some instances, the parallel Web page processing system may perform rule-matching operations for each DOM tree node on different subsets with different threads or processes, and merge matched rules together to calculate style properties. In other instances, the parallel Web page processing system may calculate style properties for a current node of a DOM tree, starting from the root node, and then calculate the style properties of its children in parallel. This process may be applied iteratively until all the nodes in the DOM tree have their style properties calculated. Additional, the Web browser may perform layout calculations and render the Web page on a display device.

In yet another aspect, a parallel Web page processing system may be configured to receive a Web page and CSS, construct a DOM tree, construct a render tree at least in part based on the DOM tree, determine dependency relationship of render tree nodes, and calculate layouts of mutual independent nodes in parallel. Additionally, the system may render the Web page on a display device.

As discussed above, computing devices that operate with multi-core processors or with multiple processors are becoming more and more prevalent and network speeds are rapidly increasing. Additionally, Web applications with heavy processing requirements are becoming the norm for businesses to provide rich interactive Web applications to users that rival desktop applications. Unfortunately, traditional Web page processing is mainly performed sequentially in a single thread manner. Thus, modern computing devices are not using their multi-processor or multi-core resources to effectively process Web pages and exploit the advances in multi-core and other parallel computing technologies. These problems, and the desire for faster Web page processing, are compounded by the ever increasing speed of network connections such as the Internet.

The techniques described in this disclosure may be used for effectively solving the foregoing problems by parsing a Web page file, executing a script engine, computing styles, and/or calculating layouts in parallel. In this way, multiple threads and/or multiple processes may parse the Web page file, compute styles, calculate layouts and/or execute script code found in the Web page in a parallel fashion. Parsing a Web page file generally involves identifying individual tagged elements for creating a DOM tree to represent the Web page in memory. Style formatting generally involves finding matching CSS rules, and computing style properties for each DOM tree node. Layout calculation generally involves constructing a render tree at least in part based on the DOM tree and performing layout calculations for each render object in the render tree. Alternatively, executing script code generally involves a script engine for executing instructions in scripts based on interactions with a user or in response to some events. By parsing Web page files, computing styles, calculating layouts, and/or executing script code in parallel, a computing device may execute many instructions at the same time without waiting for each step to complete sequentially.

Parsing a Web page file in parallel may entail fragmenting the Web page data into pieces. Once fragmented, a Web page parser may identify DOM nodes, invalid fragments, and scripting code from among the pieces. Invalid fragments may be merged with other fragments to form valid fragments. Additionally, the identified DOM nodes may be submitted to a DOM tree. Script code, on the other hand, may be submitted to a script engine for execution.

Executing script code in parallel may entail identifying independent and dependent events. A script engine may execute a set of scripts driven by dependent events sequentially and/or may execute scripts driven by independent events in parallel. Additionally, the script engine may update the DOM tree in execution of scripts. The Web browser may then determine style formatting for the Web page and construct a render tree based at least in part on the DOM tree and the style formatting. The Web browser may then calculate the layout of the Web page and render the Web page on a display device based at least in part on the render tree and the layout calculations.

Parallel computation of styles may entail dividing CSS rules into subsets and searching CSS rules for matching rules in each subset in parallel for each DOM tree node. The Web browser may then compute style properties based on the matched rules. In another aspect, parallel computation of styles may entail computing styles in parallel for DOM tree nodes without descending relationships in the DOM tree. Additionally, the Web browser may calculate layouts for render objects and render the Web page on a display device.

Parallel calculations of layouts may entail constructing a render tree at least in part based on the DOM tree, determining dependency for the render objects in the render tree, and performing layout calculations in parallel for mutually independent render objects. The Web browser may then render the Web page on a display device.

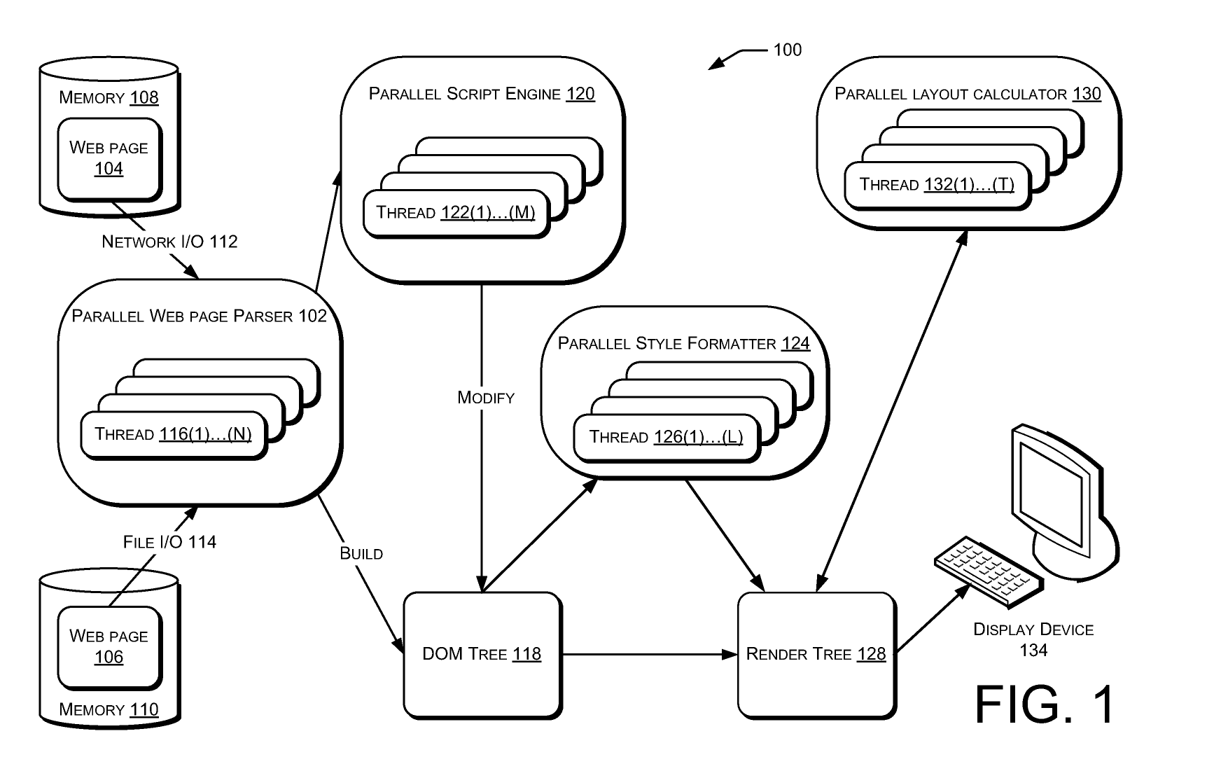

FIG. 1 depicts an illustrative system 100 that may perform parallel Web page processing. By way of example only, a parallel Web page parser 102 of a Web browser, or other application, may receive a Web page file 104 or 106 from a memory 108 or 110, respectively. In one example, the Web page file 104 may be located in a network storage device (or server) 108. In this example, the parallel Web page parser 102 may receive the Web page file 104 over a network input/output (I/O) path 112 such as a local network transmission line or the Internet. In another example, the Web page file 106 may be stored in a local memory 110 such as the computing device that implements the Web browser. In this example, the parallel Web page parser 102 may receive the HTML file 106 over a local file I/O path 114 such as a local bus.

In one aspect, the parallel Web page parser 102 may be configured to parse the Web page file 104 in parallel to determine individual tagged elements using multiple threads 116(1) through 116(N), where N is an integer of one or greater. In one example, multiple threads 116(1) through 116(N), collectively threads 116, may be executed by a single processor. In other examples, however, threads 116 may be executed by multiple processors, where each thread 116 may be executed by a different processor or where the execution of threads 116 may be spread over multiple processors in a predefined manner.

Tagged elements such as HTML elements may be identified based on HTML tags or descriptors found within the Web page file 104. In one example, the less than symbol, “<” may signify the beginning of a tag; however, in other examples, other symbols may be used. The Web browser may utilize the parsed HTML information from the parallel Web page parser 102 to build a DOM tree 118 for each individual Web page file 104. In this way, the DOM tree 116 may be built based on the parsed elements of the Web page file 104.

Additionally, in one aspect, if scripting language code, such as JavaScript™ code, is found within the Web page file 104, the Web browser may serve the script code to a parallel script engine 120. The parallel script engine 120 may be configured to execute the script code using multiple threads 122(1) through 122(M), where M is an integer of one or greater. As noted above with respect to threads 116, multiple threads 122(1) through 122(M), collectively threads 122, may be executed by a single processor or by any configuration of multiple processors. Additionally, the parallel script engine 120 may interact with a user of the Web browser, and/or modify the DOM tree 118 based at least in part on the user's interactions and/or the executed code. However, if the parallel Web page parser 102 does not detect any script code from within the Web page file 104, the Web browser may build the DOM tree 118 without being modified by the parallel script engine 120.

The Web browser may compute styles for each DOM tree node with a parallel style formatter 124. The parallel style formatter 124 may be configured to compute styles using multiple threads 126(1) through 126(L), where L is an integer of one or greater. The multiple threads 126(1) through 126(L), collectively threads 126, may be executed by a single processor or by any configuration of multiple processors. In one aspect, the parallel style formatter 124 may be configured to compute style properties for a DOM tree node by partitioning CSS rules into subsets, and searching these subsets in parallel with the multiple threads 126 for matched rules. The Web browser may then merge the matched rules from different subsets and compute style properties for the DOM tree node. In another aspect, the parallel style formatter 124 may be configured to dispatch style formatting for DOM tree nodes without descending relationships to multiple threads 126 to compute style properties for these nodes in parallel.

The Web browser may build a render tree 128 based at least in part on the DOM tree 118. In this way, the Web browser may prepare the data for appropriate layout calculations to be executed with parallel layout calculator 130. In one aspect, the Web browser may perform layout calculations based at least in part on render objects of the render tree 128. The parallel style formatter 126 may be configured to calculate render object layouts using multiple threads 132(1) through 132(T), where T is an integer of one or greater. The multiple threads 132(1) through 132(T), collectively threads 132, may be executed by a single processor or by any configuration of multiple processors. In one aspect, the parallel layout calculator 130 may be configured to determine dependencies for objects in the render tree 128, and calculate the layouts of mutual independent render objects in parallel with the threads 132(1) through 132(T). The Web browser may then render the Web page on a display device 134. By way of example only, the layout information may contain render data for visible elements of the DOM tree 118.

FIG. 1 provides a simplified example of a suitable system 100 for parallel Web page processing according to the present disclosure. However, other configurations are also possible. For example, and as described above, while a DOM tree 118 and a render tree 128 are described, other data structures may be used to represent the elements of the Web page file 104. Also, while most examples are described with reference to the Web page file 104 received over a network, any Web page file received by the Web browser may be processed for display using the principles noted above. Further, the system 100 may be configured to perform parallel Web page parsing alone, parallel scripting alone, parallel style formatting alone, parallel layout calculating along, a combination of parallel processing for some stages and sequential processing for other stages, or configured to perform all of the above stages concurrently or sequentially during processing of a single Web page.

### Illustrative Parallel Web Page Parsers

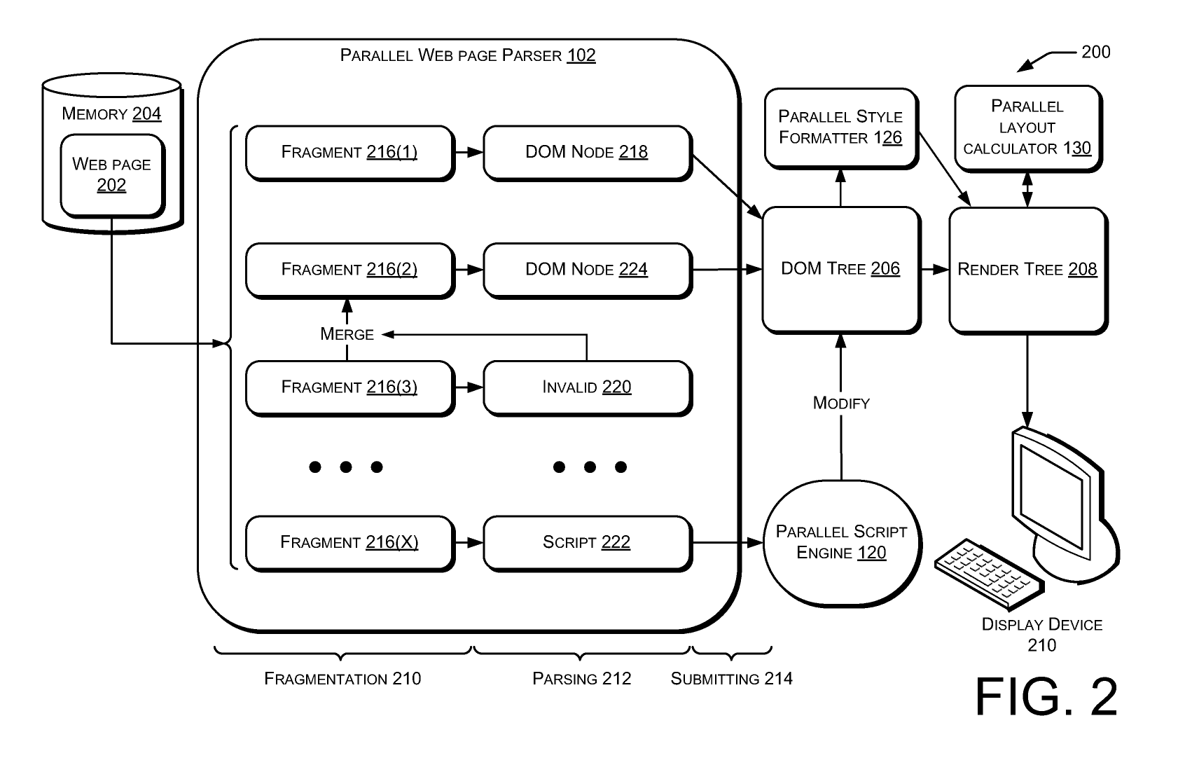

FIG. 2 depicts an illustrative system 200 for Web page processing similar to that described above regarding FIG. 1. In one aspect, the system 200 may receive a Web page file 202 associated with a requested URL from a memory 204 and process the Web page file 202 with the parallel Web page parser 102. The Web page file 202 may be received over a private or public network such as the Internet or over a local bus. Additionally, as discussed above with respect to FIG. 1, a DOM tree 206 may be constructed based at least in part on the parsed Web page file and may be modified by the parallel script engine 120. However, in one example, a sequential script engine may be used in place of the parallel script engine 120. Further, the system 200 may construct a render tree 208 based at least in part on the DOM tree 206 and may effectuate display of the Web page on a display device 210 based at least in part on the render tree 208.

By way of example and not limitation, the parallel Web page parser 102 may be described with reference to three stages, namely Fragmentation 210, Parsing 212, and Submitting 214. During Fragmentation 210, the parallel Web page parser 102 may parse the Web page file 202 into individual fragments 216(1) through 216(X), where X is an integer of one or greater. In one example, Fragmentation 210 may be effectuated by separating HTML tags according to the occurrences of the less than “<” character to form HTML fragments 216(1) through 216(X), collectively fragments 216. Since HTML tags may begin with the “<” character, this may correctly fragment each HTML tag into individual fragments 216. For example, fragment 216(1) may represent an actual HTML tagged element of the Web page file 202 that may contain the information of one or more complete DOM nodes, and, thus, may be labeled as a DOM node 218 for the DOM tree 206. However, in cases where the “<” character is not the beginning of an HTML tag, for example when the character was used to signify “less than” in a mathematical equation, the parallel HTML parser 102 may create an incorrect HTML tag. As such, the incorrect tag may not accurately represent an HTML element for the DOM tree 206. For example, fragment 216(3) may represent an incorrectly fragmented HTML tag of the Web page file 202 because the “<” character may not have represented the beginning of a tag (e.g., “x<5”). In this example, fragment 216(3) may be labeled as “invalid” 220 because the “<” character was not intended to begin a new tag. When an invalid fragment is detected, its parsed result may be useless and thus abandoned, and its contents may be merged into the previous fragment for further parsing. In this example, invalid fragment 216(3) may merge with a previous fragment 216(2) that can be successfully parsed, for example, another DOM node 224 for DOM tree 206. Additionally, while the “<” character is shown as the beginning of a tag, other beginning indicators may be envisioned.

As noted above, the parallel Web page parser 102 may operate with multiple threads or multiple processes. As such, Fragmentation 210 may be performed in parallel such that multiple tagged elements are parsed at the same time. Additionally, the parallel Web page parser 102 may iteratively perform Fragmentation 210 until each “<” character is found, until each HTML tag is recognized, or until the entire Web page file 202 has been processed.

In another example, during Parsing 212, the parallel Web page parser 102 may parse each fragment 216 to identify DOM nodes 218 and/or script 222. As noted above, DOM nodes 218 may be those fragments 216 that accurately represent a valid tagged element of the Web page file 202. Also, as noted above, “invalid” nodes 220 may be those fragments 216 that do not accurately represent a valid tagged element of the Web page file 202. On the other hand, script 222 may be those fragments in the Web page file that are parsed into script code. By way of example only, script 222 may be used to interact with one or more users.

Additionally, during Parsing 212, the parallel Web page parser 102 may merge fragments 216 determined to be “invalid” 220 with the immediately preceding fragments 216. For example, as shown in FIG. 2, if fragment 216(3) is determined to be “invalid” 220, the parallel Web page parser 102 may merge fragment 216(3) with the immediately preceding fragment 216(2) because it was fragmented from the immediately preceding portion of the Web page file 202. A merged fragment 216 may be parsed to a DOM node 224. It may also be parsed into script 222. In this way, parallel Web page parser 102 can parse a Web page file 202 correctly into DOM nodes for the DOM tree 206 and into scripts to be executed by the script engine 120. As noted above, parallel Web page parser 102 may process the fragmentation 210 with multiple threads and/or multiple processes; therefore, parallel Web page parser 102 may keep track of the starting and ending position of each fragment 216. This way, “invalid” fragments 220 may be accurately merged with the immediately preceding fragment 216 even when the fragments are formed out of order.

In yet another example, during Submitting 214, the parallel Web page parser 102 may submit parsed results of each valid fragment 216 to either the DOM tree 206 or the parallel script engine 120. By way of example only, the parallel Web page parser 102 may submit parsed results of fragments 216 that represent DOM nodes (such as DOM node 218) and/or parsed results of merged fragments 216 that represent nodes (such as block 224). In this way, the system 200 may construct the DOM tree based on the HTML elements parsed from the Web page file 202. Additionally, and also by way of example only, the parallel Web page parser 102 may submit parsed results of fragments 216 that represent script code (such as script 222) or parsed results of merged fragments 216 that represent script code to the parallel script engine 120.

FIG. 2 provides a simplified example of a suitable system 200 for parallel Web page processing according to the present disclosure. However, other configurations are also possible. For example, and as described above, while both a parallel Web page parser 102 and a parallel script engine 120 are shown being executed together, the system 200 may be configured to operate with or without either the parallel Web page parser 102 or the parallel script engine 120. For example, and as noted above, the system 200 may be configured to include the parallel Web page parser 102 and a sequential script engine.

### Illustrative Parallel Script Engines

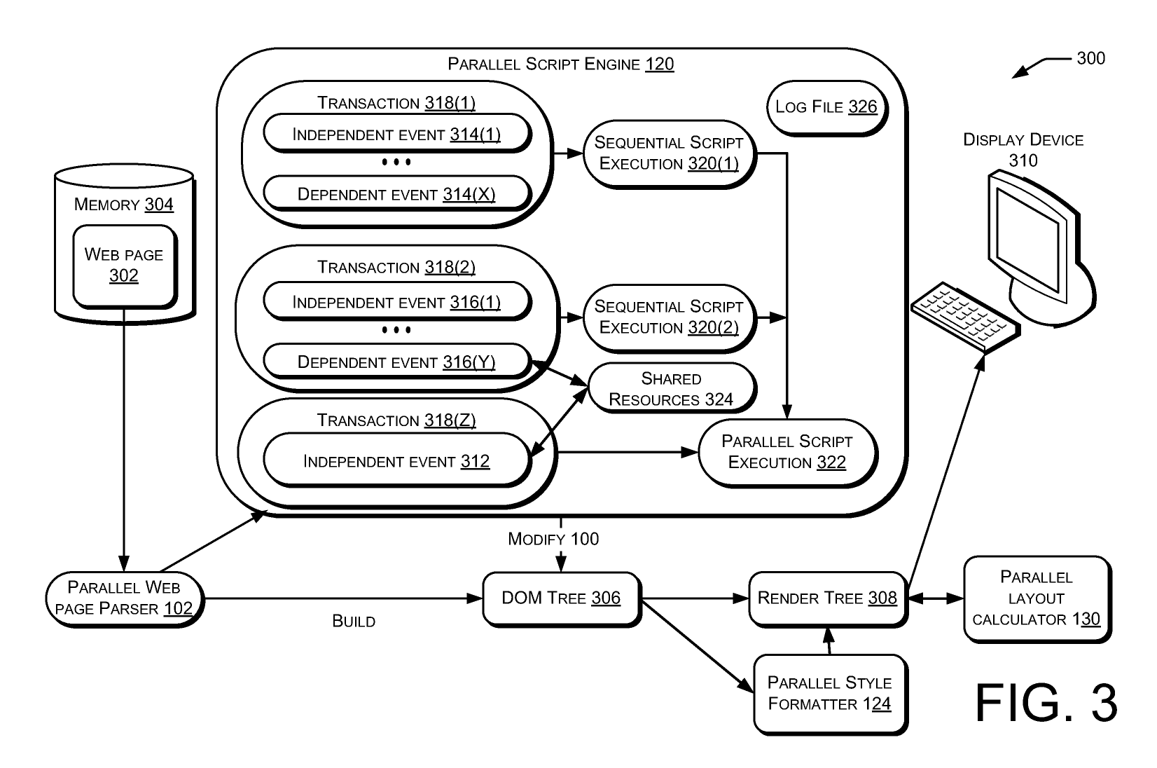

FIG. 3 depicts an illustrative system 300 for Web page processing similar to that described above regarding FIGS. 1 and 2. In one aspect, the system 300 may receive a Web page file 302 associated with a requested URL from a memory 304 and process the Web page file 302 with the parallel Web page parser 102. However, in one example, a sequential Web page parser may be used in place of the parallel Web page parser 102. Web page file 302 may be received over a private or public network such as the Internet or over a local bus. Additionally, as discussed above with respect to FIGS. 1 and 2, a DOM tree 306 may be constructed based at least in part on the parsed Web page file and may be modified by the scripts executed by the parallel script engine 120. Further, the system 300 may construct a render tree 308 based at least in part on the DOM tree 306 and may effectuate display of the Web page on a display device 310 based at least in part on the render tree 308.

In one aspect, the parallel script engine 120 may receive scripts from the parallel Web page parser 102. In one example, all scripting events may be ordered according to the times they occur. The Web browser may use a set to record all the occurred events. The Web browser may start with an empty set, then add the first scripting event to the set, then add the second scripting event to the set, and repeat this procedure until all the scripting events are included in the set. In one example, all the scripting events are independent of each other, such as event 312 and event 314(1) in FIG. 3 are independent of each other. The scripts driven by these mutually independent scripting events may be dispatched to different threads or processes to run in parallel. In this example, the script driven by event 312 and that driven by event 314(1) may run in parallel in two threads. Whenever a new scripting event occurs, the Web browser determines its relationship with previous events. In one example, if a new event is determined to be dependent on a previous event, the script driven by the new event may be dispatched to the same thread that runs the script driven by the previous event on which the new event depends. In this case, the two scripts run in the same thread sequentially as a transaction. As shown in FIG. 3, event 314(2) may depend on event 314(1). Their scripts may run sequentially in a same thread as a transaction 318(1). In another example, if a new event is determined to be independent of the previous events, the script driven by the new event may be dispatched to a new thread to run in parallel with the scripts driven by the previous events. In the example shown in FIG. 3, event 316(1) is determined to be independent of previous events 312, 314(1) and 314(2), thus, its script may be dispatched to a new thread to run in parallel with the previous scripts.

As mentioned previously, all scripting events are recorded together with their occurring times. These events may also be ordered according to their occurring times. In one aspect, when a new scripting event occurs, the Web browser may determine its relationship with previously occurring scripting events. When two User Interface (UI) events occurred on a same UI element, the Web browser may determine that the later occurred event depends on the earlier occurred event. The Web browser may also determine that a keyup event depends on an earlier occurred keydown event, and a mouseup event depends on an earlier mousedown event. If a timer is set or an AJAX request is triggered during execution of a handler script of an event A, the Web browser may determine that the timeout event or AJAX callback depends on event A.

In another aspect, the system disclosed herein may introduce a threading support mechanism with some synchronous primitives in the scripting language to allow programmers to specify relationships among scripts. Such a relationship may determine if two scripts may be run sequentially or in parallel. In this mechanism, a DOM may always be a shared resource accessible by any thread. A shared object or resource may be declared explicitly as shared. The parallel scripting engine 120 may make operations on a shared object or resource atomic. A critical section may be allowed to specify explicitly to protect resources or synchronize threads. Additionally, UI events may occur in different DOM elements or may be treated implicitly as independent. The system may introduce a new HTML tag or script property to explicitly allow a specification that one event depends on another. The scripts whose events have dependent relationships may be executed in a transaction. The system may also introduce an Application Programming Interface (API) to allow a program to manually create concurrent threads rather than run in parallel with the main thread.

In one aspect, a set of scripts whose events are related by dependencies may run as a transaction in a single thread. By way of example and not limitation, the parallel script engine 120 may determine that events 314(1) through event 314(X), where X is an integer of one or larger, collectively as events 314, are a set of events with dependent relationships, and may run their scripts as a single transaction 318(1) in a thread in a sequential script execution 320(1) manner. The parallel script engine 120 may also determine that events 316(1) through 316(Y), where Y is an integer of one or greater, collectively as events 316, are a set of events with dependent relationships, and may run their scripts as a single transaction 318(2) in a thread in a sequential script execution 320(2) manner. The parallel script engine 120 may also determine that event 312 is independent of other events, and events 314 are independent of events 316, and may run the script driven by event 312, the set of scripts driven by events 314, and the set of scripts driven by events 316 in parallel with parallel script execution 322.

In another aspect, the parallel script engine 120 may receive scripts from the parallel Web page parser 102. Some scripts may access shared resources 324. Shared resources 324 may be shared data or objects such as the DOM tree 306 that can be accessed by many scripts. Shared resources may not allow modifications and accesses simultaneously by multiple scripts. As such, the parallel script engine 120 may keep track of accesses and changes to shared resources 324 to detect conflicts in the parallel execution of scripts. During execution, as well as at the end, of a script (or scripts) in a transaction, if a conflict is detected, the execution may be determined to be invalid and thus abandoned.

The parallel script engine 120 may record all accesses and changes to shared resources 324 during execution of transactions 318 in a log file 326. The parallel script engine 120 may also record a copy of shared resources 324 before each modification so that the modification can be reversed if the parallel script engine 120 determines later that the modification is invalid. Additionally, the parallel script engine 120 may store a start-up time for each transaction 318 in the log file 326. In one example, after a transaction 316 is executed, the parallel script engine 120 may check the log file and invalidate a transaction 316 based at least in part on the recorded data in the log file 326 during execution. By way of example and not limitation, in FIG. 3, both the script driven by event 316(Y) and the script driven by event 312 may access shared resource 324. Thus, if transaction 318(Z), which executes the script driven by event 312 has an earlier start-up time than transaction 318(2), which executes event 316(1) through 316(Y), but has access to the part in shared resource 324 that was modified by the script driven by event 316(Y) running in parallel, transaction 316(1) will be invalidated because it will effect the execution of transaction 316(Z). In this case, the changes to shared resource 324 made by the script driven by event 316(Y) are reversed to restore the original state of the shared resource 324 so that transaction 318(Z) can access shared resource 324 without any modification by the later-started transaction 318(2). Transaction 318(2) would be executed again when transaction 318(Z) is complete and determined valid. At the end of execution of transaction 318, if the parallel script engine 120 determines that the transaction is valid, the transaction is complete and its results may be committed.

Further, in one aspect, the parallel script engine 120 may dispatch a set of scripts driven by dependent event chain 314 to a single thread to perform sequential script execution 320(1). The execution of these scripts 314 is treated as a transaction 318(1). Similarly, the parallel script engine 120 may dispatch the scripts driven by dependent event chain 316 to a single thread to perform sequential script execution 320(2), and treat execution of these scripts as a transaction. The parallel script engine 120 may treat execution of the script driven by independent events 312 as a transaction 318(Z). On the other hand, the parallel script engine 120 may perform parallel script execution 322 on transactions 318(1) through 318(Z). This parallel execution may be done by dispatching the script driven by independent event 312, the scripts driven by dependent event chain 314, and the scripts driven by dependent event chain 316 to different threads. In this way, scripts driven by mutual independent events may be performed in parallel utilizing multiple threads and/or multiple processes while scripts driven by events related to each other by dependency may be performed in sequential processing. Additionally, when an operation by any script in a transaction is determined to be invalid, the operations by all the scripts in that transaction are also determined to be invalid and abandoned. In other words, execution of scripts in a transaction is treated as an atomic operation. They either succeed or fail as a whole.

FIG. 3 provides a simplified example of a suitable system 300 for parallel Web page processing according to the present disclosure. However, other configurations are also possible. For example, and as described above, while both a parallel HTML parser 102 and a parallel script engine 120 are shown being executed together, the system 300 may be configured to operate with or without either the parallel HTML parser 102 or the parallel script engine 120. For example, and as noted above, the system 300 may be configured to include the parallel script engine 120 and a sequential HTML parser. It is also possible to configure the system 300 to combine parallel or sequential processing of style formatting and/or parallel or sequential processing of layout calculations. Additionally, the system 300 may contain shared resources 324 that are shared by some scripts or other global resources that are not shared by other scripts.

### Illustrative Parallel Style Formatting Methods

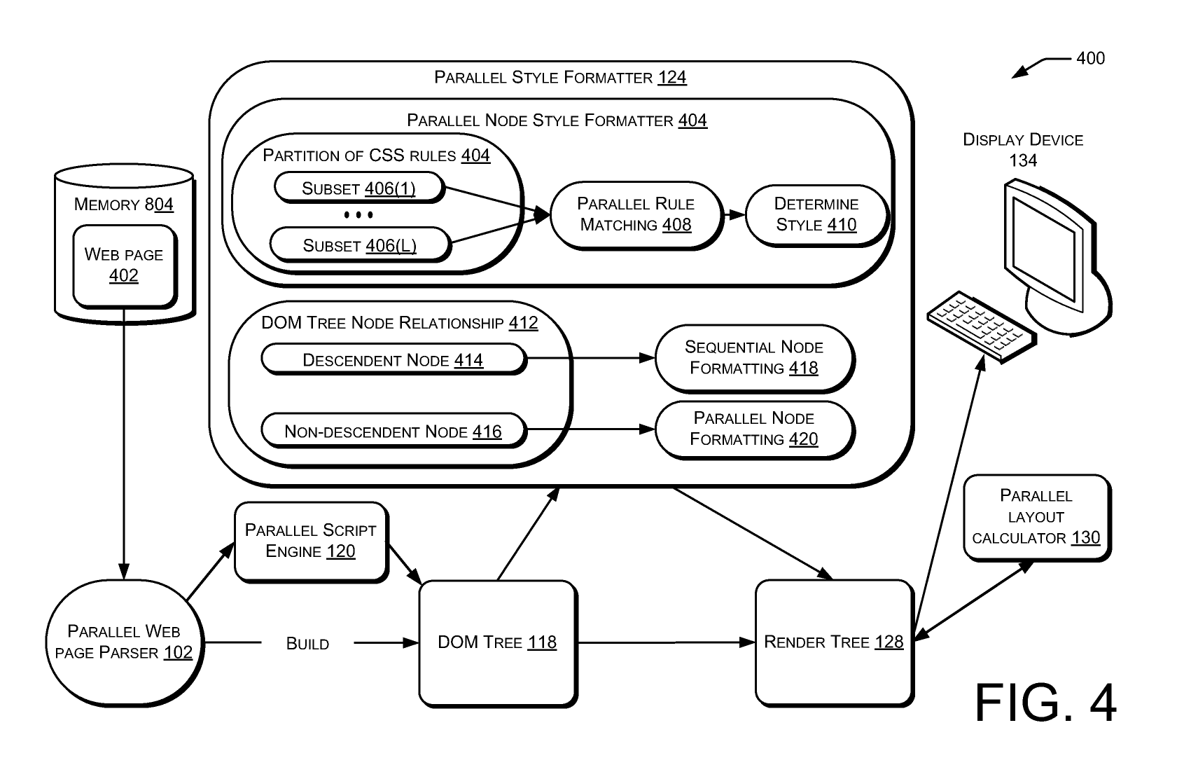

FIG. 4 depicts an illustrative system 400 for implementing a parallel style formatter 124 similar to that described above regarding FIGS. 1 through 3. In one aspect, the system 400 may receive a Web page file 402 associated with a requested URL from a memory 404, process the Web page file 402 with the parallel Web page parser 102, and execute scripts with parallel script engine 120. Additionally, as discussed above with respect to FIGS. 1 through 3, a DOM tree 118 may be constructed based at least in part on the parsed Web page file and may be modified by the scripts executed by parallel script engine 120. A parallel style formatter 124 may be applied to compute style properties for each DOM tree node. Further, the system 400 may construct a render tree 128 based at least in part on the DOM tree 118, may calculate layouts for render objects with parallel layout calculator 130, and may effectuate display of the Web page on a display device 134 based at least in part on the render tree 128.

In one aspect, the parallel style formatter 124 may check node relationships at block 412 for each node in the DOM tree 118 against the DOM tree nodes that have started to compute style properties but have yet to finish (referred to as ongoing processing nodes), starting from the root node. In some instances, if the parallel style formatter 124 determines that a node is a descendent of an ongoing processing node, the node may be dispatched to a sequential node formatting mode waiting for all its ascendant nodes to be style-formatted before its style it is formatted. In other instances, if the parallel style formatter 124 determines that a node is not a descendent of any ongoing processing node(s), the node may be dispatched to a parallel node formatting mode where its style is formatted in parallel with the parallel style formatter 124 that is computing the styles for the ongoing processing node(s).

By way of example and not limitation, the parallel style formatter 124 may determine a descendent node 414 of some ongoing processing node, and may compute the style properties of node 414 in sequential node formatting mode 418. In a sequential formatting mode 418, a node may not start to compute its style properties until the computation of the styles of all its ascendant nodes has completed. In other instances, the parallel style formatter 124 may determine a non-descendent node 416 which is not a descendent of any ongoing processing node(s), and may start to compute the style properties of node 416 in a thread different from the threads that are processing the ongoing processing node(s). In this case, the style formatting of node 416 is in parallel with the style formatting of the ongoing processing nodes.

The parallel style formatter 124 may use a parallel node style formatter 404 to compute style properties for a DOM tree node. The parallel node style formatter 404 may partition all the CSS rules into subsets 406(1) through 406(L), where L is an integer of 1 or greater. These subsets may then pass to parallel rule matching block 408 in which multiple threads may be used to find matched rules, a thread checks the rules in one or more subsets to find matched rules. All the matched rules from different subsets may then be merged together, and the style properties of the node are then determined at block 410.

### Illustrative Parallel Layout Calculation Methods

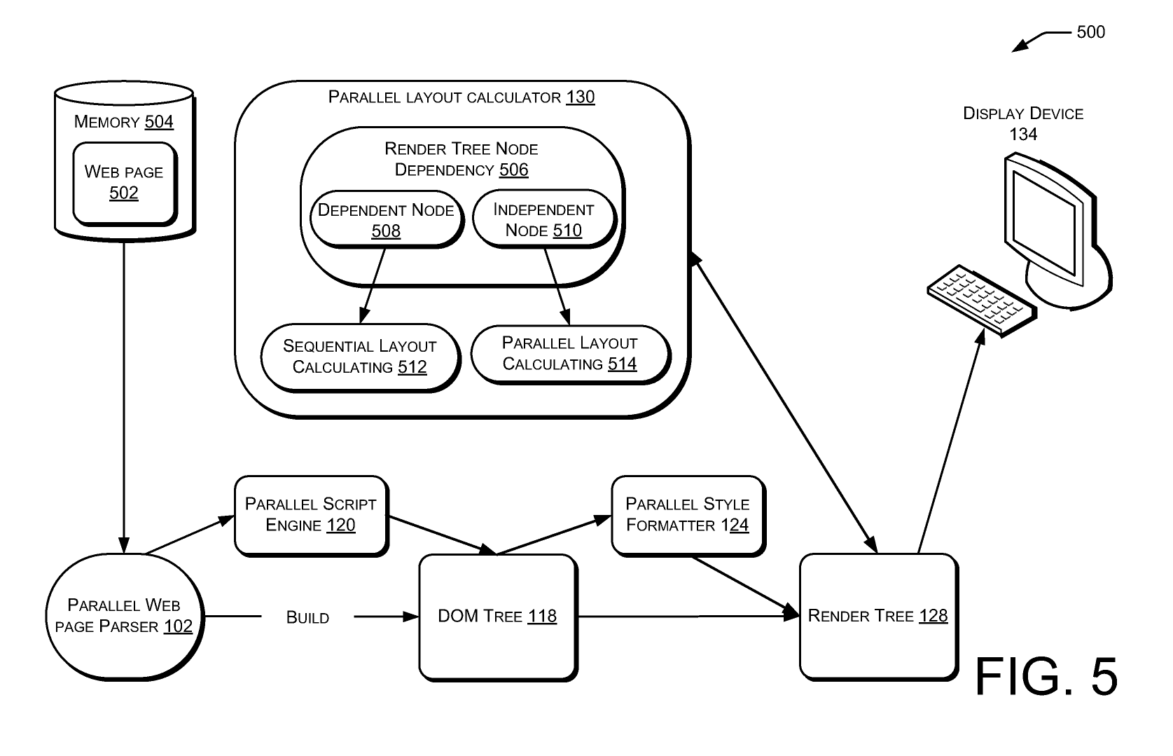

FIG. 5 depicts an illustrative system 500 for implementing a parallel layout calculator 130 similar to that described above regarding FIGS. 1 through 3. In one aspect, the system 500 may receive a Web page file 502 associated with a requested URL from a memory 504, process the Web page file 502 with the parallel Web page parser 102, and execute scripts with parallel script engine 120. Additionally, as discussed above with respect to FIGS. 1 through 3, a DOM tree 118 may be constructed based at least in part on the parsed Web page file and may be modified by the scripts executed by parallel script engine 120. A parallel style formatter 124 may be applied to compute style properties for each DOM tree node. Further, the system 500 may construct a render tree 128 based at least in part on the DOM tree 118. A parallel layout calculator 130 may be applied to calculate the layouts for the render objects in the render tree 128. The system 500 may effectuate display of the Web page on a display device 134 based at least in part on the render tree 128.

Layout calculation may be performed to determine the size and position of render objects. When no style is specified, the elements are processed in a pre-order manner. The size of one element may be determined by itself and all its descendants and the position of one element may be determined by the size and position of its father and left intermediate sibling in the render tree. In this case, the layout calculation may be processed sequentially, one node at a time, in a pre-order manner. However, CSS styles may be commonly used in order to create different kinds of effects, including position and size. Layout calculation of render objects may be executed in a parallel manner.

In one aspect, the parallel layout calculator 130 may start with the root node in a render tree 128 to calculate the layout for each node in the render tree 128. For each node, the parallel layout calculator 130 may determine if the layout of the node depends on other nodes whose layouts are still in processing. In one instance, the parallel layout calculator 130 may determine that a current render tree node is a dependent node 508 whose layout depends on the layout of another node that is still under processing, and the parallel layout calculator may dispatch its layout calculation to a sequential layout calculating mode 512, in which calculation of its layout will not start until the layouts of all the nodes that it depends on have been calculated. In another instance, the parallel layout calculator 130 may determine that a current render tree node is a dependent node 510 whose layout does not depend on the layout of the nodes that are still under processing, and dispatch its layout calculation to a parallel layout calculating mode 514, in which calculation of its layout is in parallel with the existing layout calculations.

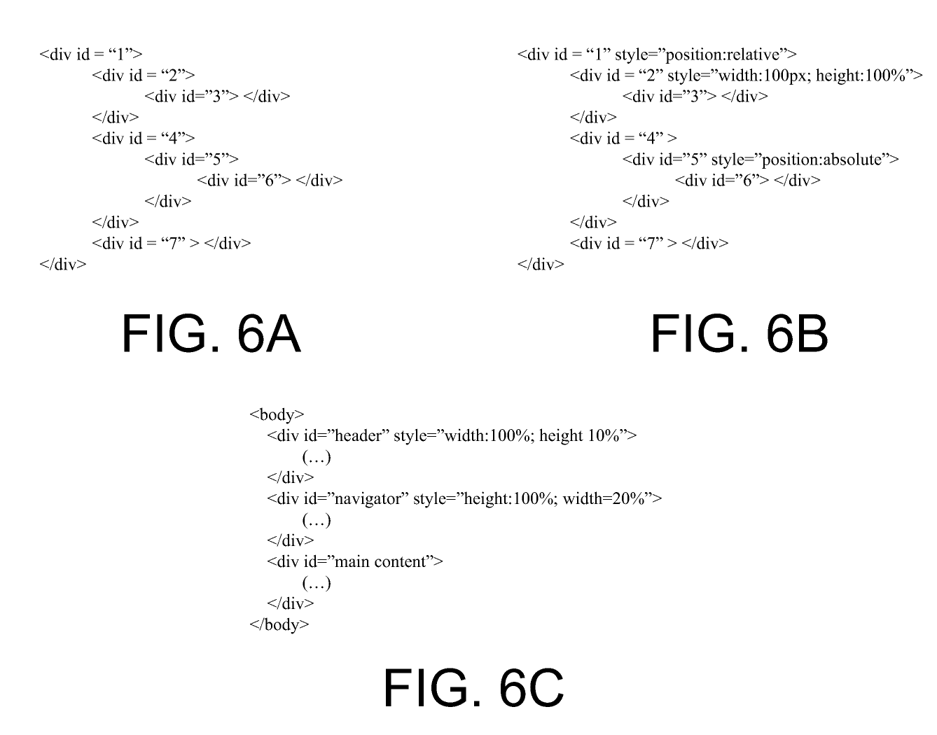

FIG. 6 depicts three examples for determining dependencies in calculating layouts. FIG. 6A shows a case where no layout style is specified. In this case, the parallel layout calculator 130 calculates the layout for these nodes sequentially in the order of 1, 2, 3, 4, 5, 6, 7, since each node depends on the previous one in that chain of nodes. FIG. 6B shows another example where layout styles are used. In this case, node 1 is processed first. The size of node 2 can be determined immediately. Node 5 has absolute positioning. Its location is determined within its containing block, which happens to be node 1 according to CSS Specification. In this example, the layout of node 3 depends on node 2, node 6 depends on node 5, and node 7 depends on node 4. The parallel layout calculator 130 may execute layout calculations in the following way: first calculate node 1's layout, then calculate the layouts of other nodes in parallel with three threads: nodes 2 and 3 in one thread, nodes 5 and 6 in another thread, and nodes 4 and 7 in a third thread. In each thread, a preceding node is calculated first. At the end of parallel calculations, the parallel layout calculator 130 combines the results from different threads. FIG. 6C shows a typical Web page where layout styles appear at top levels, and layout calculation can be readily executed in parallel for faster processing.

### Illustrative Parallel Web Page Processing Methods

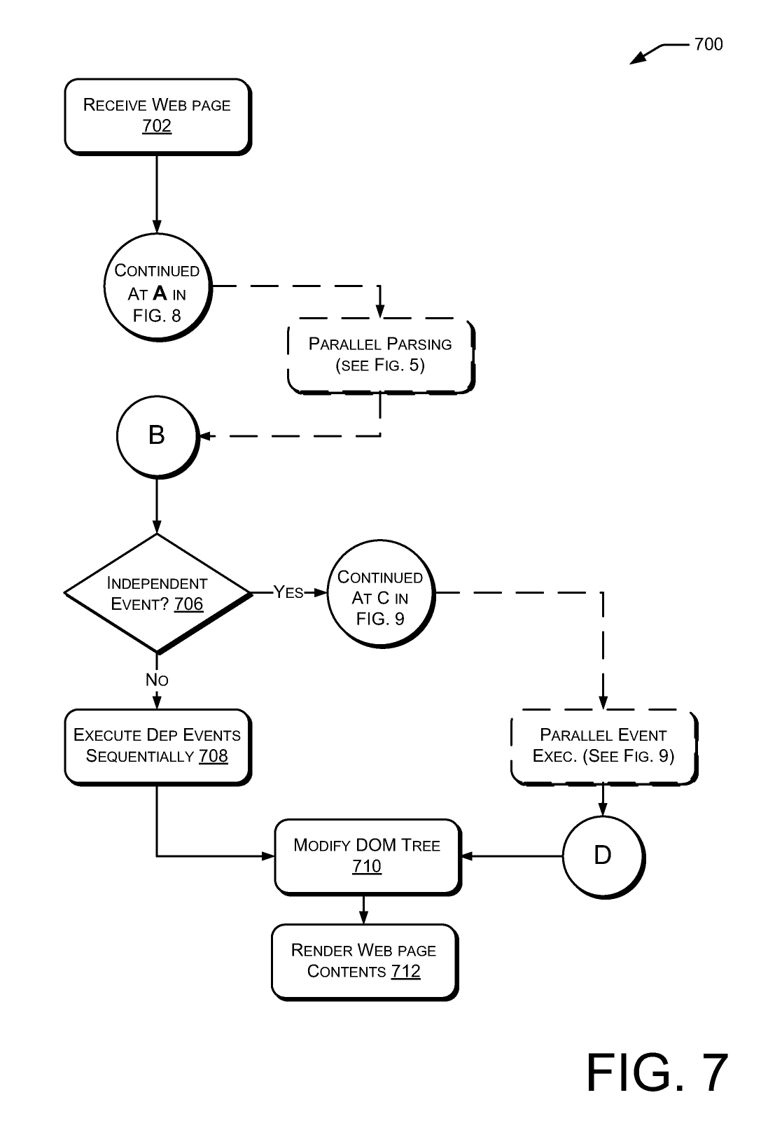

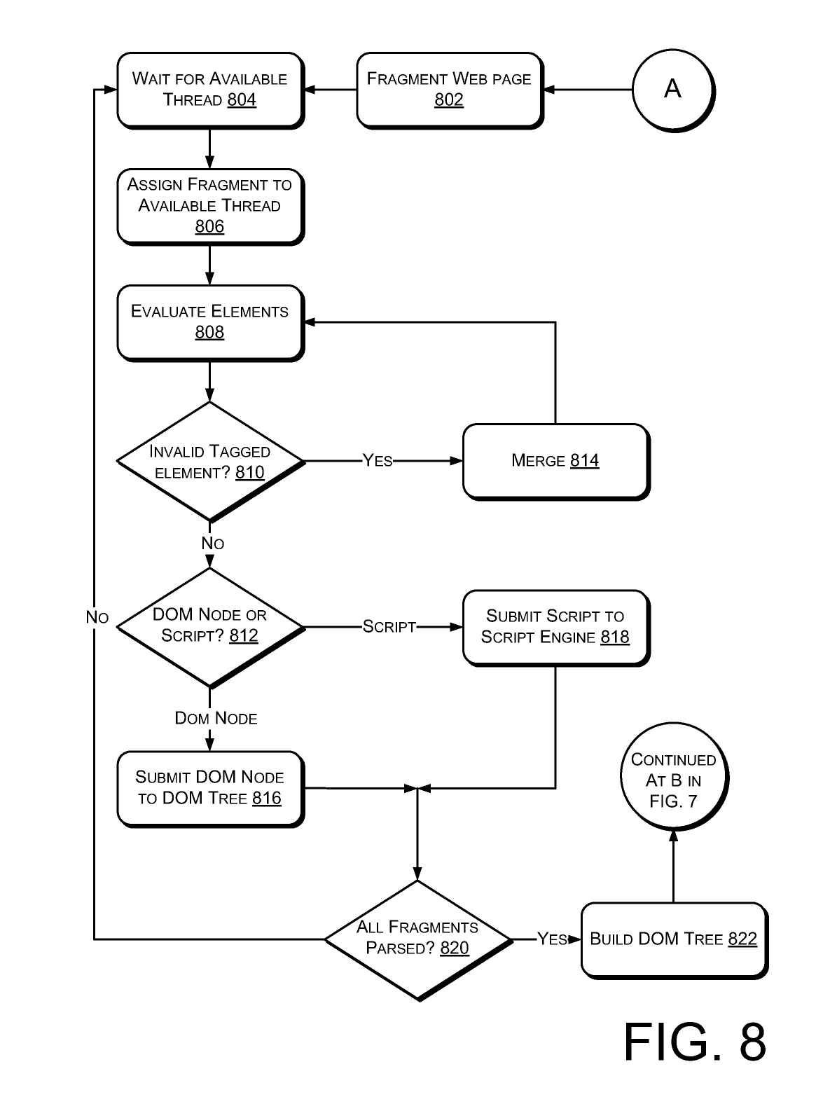

FIGS. 7-9 are flow diagrams of one illustrative method 700 for implementing parallel Web page processing as described with reference to at least FIGS. 1-5. As discussed above, parallel Web page processing may be responsible for parsing HTML files in parallel and executing a parallel script engine. In this particular implementation, the method 700 may begin at block 702 of FIG. 7 in which the method 700 may receive a Web page file upon a request to access a URL. Generally, as noted above, the Web page files may be received over a local bus or over a private or public network. As such, the method 700 may receive the Web page file directly over the Internet or from a local HTML cache. The method 700 then continues to “A” of FIG. 8 where parallel parsing may be performed.

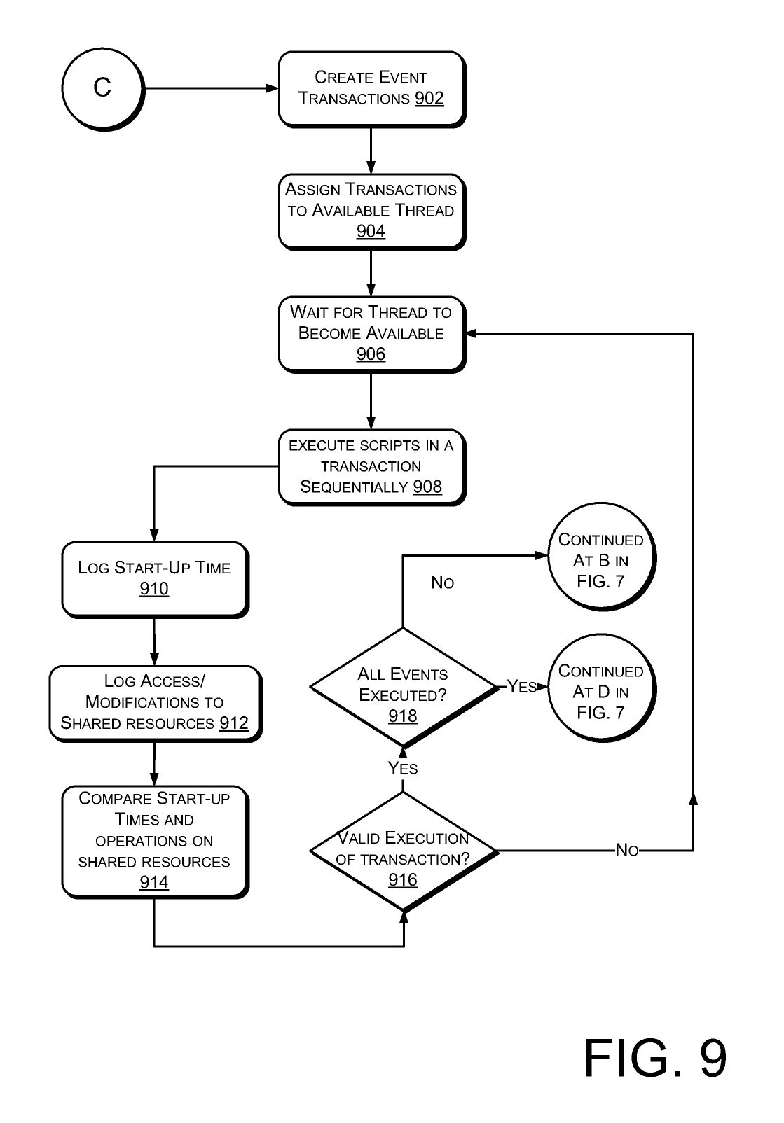

Following the parallel parsing of FIG. 8, the method 700 may determine whether events are independent of previous events at decision block 706. If the method 700 determines that an event is independent of previous events, the method 700 may continue to “C” of FIG. 9 where parallel event execution may be performed. On the other hand, if the method 700 determines that an event is dependent on a previous event, the method may execute the script of driven by the dependent event sequentially with the scripts driven by the events it depends on. Additionally, the method 700 may modify a DOM tree at block 710 during execution of scripts and render the Web page contents on a display device at block 712. At block 712, the method 700 may terminate by rendering the Web page contents on a display device.

At FIG. 8, the method 700 may continue from block 702 of FIG. 7 to perform parallel parsing. At block 802, the method 700 may fragment the Web page file in parallel into tagged elements. At block 804, the method 700 may wait for an available thread or processor to be available for the next fragmented tag. The method 700 may assign a tagged element to an available thread at block 806 and evaluate the elements of the assigned fragment at block 808. Evaluating the elements at block 808 may entail determining if an element is a DOM node, an “invalid” tagged fragment, or a scripting event, as discussed above with reference to FIG. 2. At decision block 810, the method 700 may determine if a fragment under evaluation is valid. If not, the method 700 merges the invalid fragment with its preceding fragment at block 814. The merged fragment is further evaluated at block 808.

On the other hand, if the method 700 determines that a fragment is a valid tagged element and its following fragment is valid (i.e., not merged into it), the method 800 may then determine if it contains information about one or more DOM node or script(s). In one instance, the method 700 may determine that it contains information about one or more DOM nodes, and may submit the information to the DOM tree at block 816. In another instance, the method 700 may determine that it contains script(s), and submits the scripts to the script engine at block 818.

The method 700 may proceed to a decision block 820 to determine if all the fragments have been processed. If not, the method may return to block 804 to process the next fragments. Otherwise the method 700 may build a DOM tree at block 822, and then proceed to “B” in FIG. 7 for parallel execution of scripts.

At FIG. 9, the method 700 may continue from decision block 706 of FIG. 7, or from blocks 824 to perform parallel script processing. At block 902, the method 700 may create an event transaction where all the scripts driven by events related with dependency are executed in a transaction. The method 700 may assign a transaction to an available thread or processor at block 904 and then wait for the next available thread or processor at block 906. The method 700 may execute the scripts in a transaction at block 908. During execution, the method 700 may record the start-up time of the transaction (i.e., the first script in the transaction) in a log file at block 910. The method 700 may also record each access and modification of a shared resource and also make a copy of the shared resource before each modification at 912. The method 700 may compare, at block 914, the start-up times of transactions executed in parallel and their accesses and modifications of shared resources. At decision block 916, if the method 700 determines that execution of a transaction is invalid, the execution of that transaction is reversed and its results are abandoned. The scripts in that transaction may wait for an available thread at block 906, and then be executed again in a transaction at block 908. If the method 700 determines, at decision block 916, that a transaction is valid, the execution of the transaction may be committed. The method 700 may check at decision block 918 if all the events are processed. If not, it proceeds to “B” in FIG. 4 to process more events. Otherwise the method 700 proceeds to “D” in FIG. 7.

### Illustrative Computing Environment

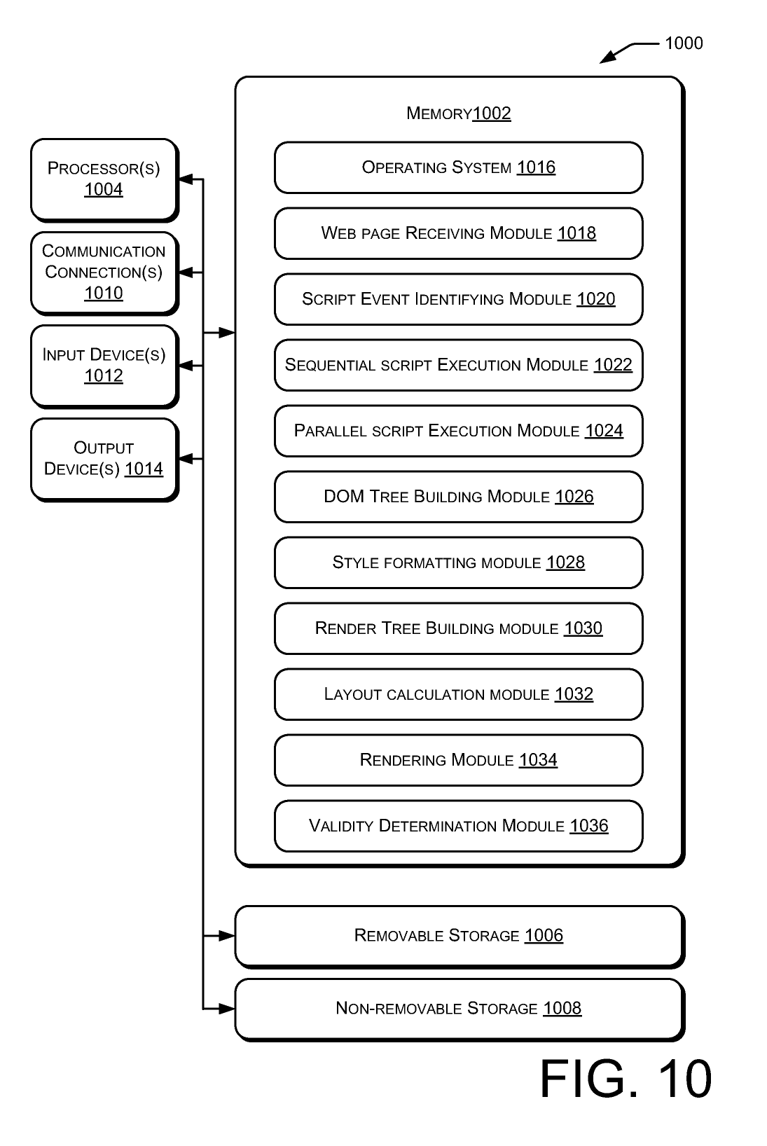

FIG. 10 provides an illustrative overview of one computing environment 1000, in which aspects and features disclosed herein may be implemented. The computing environment 1000 may be configured as any suitable computing device capable of implementing a parallel Web page processing system, and accompanying methods, such as, but not limited to those described with reference to FIGS. 1-10. By way of example and not limitation, suitable computing devices may include personal computers (PCs), servers, server farms, datacenters, or any other device capable of storing and executing all or part of the parallel processing.

In one illustrative configuration, the computing environment 1000 comprises at least a memory 1002 and one or more processing units (or processor(s)) 1004. The processor(s) 1004 may be implemented as appropriate in hardware, software, firmware, or combinations thereof. Software or firmware implementations of the processor(s) 1004 may include computer-executable or machine-executable instructions written in any suitable programming language to perform the various functions described.

Memory 1002 may store program instructions that are loadable and executable on the processor(s) 1004, as well as data generated during the execution of these programs. Depending on the configuration and type of computing device, memory 1002 may be volatile (such as random access memory (RAM)) and/or non-volatile (such as read-only memory (ROM), flash memory, etc.). The computing device or server may also include additional removable storage 1006 and/or non-removable storage 1008 including, but not limited to, magnetic storage, optical disks, and/or tape storage. The disk drives and their associated computer-readable media may provide non-volatile storage of computer readable instructions, data structures, program modules, and other data for the computing devices. In some implementations, the memory 1002 may include multiple different types of memory, such as static random access memory (SRAM), dynamic random access memory (DRAM), or ROM.

Memory 1002, removable storage 1006, and non-removable storage 1008 are all examples of computer-readable storage media. Computer-readable storage media includes, but is not limited to, volatile and non-volatile, removable and non-removable media implemented in any method or technology for storage of information such as computer-readable instructions, data structures, program modules or other data. Memory 1002, removable storage 1006, and non-removable storage 1008 are all examples of computer storage media. Additional types of computer storage media that may be present include, but are not limited to, phase change memory (PRAM), SRAM, DRAM, other types of RAM, ROM, electrically erasable programmable read-only memory (EEPROM), flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can be accessed by the server or other computing device. Combinations of any of the above may also be included within the scope of computer-readable storage media.

The computing environment 1000 may also contain communications connection(s) 1010 that allow the computing environment 1000 to communicate with a stored database, another computing device or server, user terminals, and/or other devices on a network. The computing environment 1000 may also include input device(s) 1012 such as a keyboard, mouse, pen, voice input device, touch input device, etc., and output device(s) 1014, such as a display, speakers, printer, etc.

Turning to the contents of the memory 1002 in more detail, the memory 1002 may include an operating system 1016 and one or more application programs or services for implementing parallel Web page processing including a Web page receiving module 1018. The Web page receiving module may be configured to receive Web page files from a memory, such from a local storage device accessible over a local bus or a network accessible server.

The memory 1002 may further include a scripting event identifying module 1020. The scripting event identifying module 1020 may be configured to identify scripting events from a parsed HTML file. As discussed above, scripting events may be found within parsed HTML files and may be independent events or dependent events. Additionally, scripting event identifying module 1020 may be further configured to determine whether the identified scripting events are independent or dependent.

The memory 1002 may further include a sequential script execution module 1022 and a parallel script execution module 1024. As discussed above, the sequential script execution module 1022 may be configured to execute the scripts driven by events related with dependency in sequential order. Alternatively, and also as noted above, the parallel script execution module 1024 may be configured to execute scripts driven by independent events in parallel.

The memory 1002 may further include a DOM tree building module 1026, and a rendering module 1028. The DOM tree building module 1026 may be configured to generate DOM trees to represent the received Web page file in memory. Additionally, the DOM tree building module 1026 may be configured to receive modifications from both the sequential script execution module 1022 and the parallel script execution module 1024. The style formatting module 1028 may be configured to compute style properties for each DOM tree node. The rendering module 1030 may be configured to receive DOM trees from the DOM tree building module 1026, construct render trees based at least in part on the DOM tree. The layout calculation module 1032 may be configured to calculate layout for each render object. The rendering module may render the Web page on a display device.

The memory 1002 may further include a validity determination module 1030 configured to validate executed event transactions. In one aspect, the validity determination module 1030 may base the validity of executed transactions on a comparison of start-up times and shared resources that were accessed and changed. For example, and as noted above, a first transaction that modifies shared resources that are then accessed by an earlier-started transaction may be invalid. An invalid transaction may be reversed and its execution results may be abandoned. The scripts in an invalid transaction may then be re-executed.

Illustrative methods and systems of parallel web page processing are described above. Some or all of these systems and methods may, but need not, be implemented at least partially by an architecture such as that shown in FIG. 10. It should be understood that certain acts in the methods need not be performed in the order described, may be rearranged, modified, and/or may be omitted entirely, depending on the circumstances. Also, any of the acts described above with respect to any method may be implemented by a processor or other computing device based on instructions stored on one or more computer-readable storage media.

### CONCLUSION

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

What is claimed is:

1. A computer-implemented method comprising:
performed by one or more processors executing computer-readable instructions:
receiving a Web page file;
parsing the Web page file in parallel;
determining whether an identified scripting language event depends on a preceding scripting language event;
executing, in parallel, a script driven by a scripting language event independent of a preceding scripting language event along with another script driven by a previous scripting language event;
executing, sequentially, a script driven by a dependent scripting language event following the execution of the script driven by the scripting language event that the dependent scripting event depends on; and
rendering contents of the Web page file on a display device based at least in part on a document object model (DOM) tree.

2. The computer-implemented method of claim 1, wherein executing the script in parallel comprises dispatching items to be executed in parallel for running by different threads or processes.

3. The computer-implemented method of claim 1, further comprising fragmenting the Web page file into tagged fragments based at least in part on identifying a beginning indication of a tagged element found in the Web page file and labeling each tagged fragment, the labeling of each tagged fragment comprising sequentially labeling text between a first beginning indication of a tagged element and a next beginning indication of a tagged element prior to parsing the tagged elements in parallel.

4. The computer-implemented method of claim 3, further comprising:
determining whether a tagged fragment is invalid; and
merging each invalid tagged fragment with a sequentially preceding tagged fragment prior to parsing the tagged elements in parallel.

5. The computer-implemented method of claim 1, wherein determining whether an identified scripting language event depends on a preceding scripting language event comprises determining, a priori, a dependency relationship between the identified scripting language event and the preceding scripting language event based at least in part on an event information rule.

6. The computer implemented method of claim 5, wherein the event information rule states that a first scripting language event depends from a second scripting language event when two or more user interface (UI) events occur on a same UI element.

7. The computer implemented method of claim 5, wherein the event information rule states that a first scripting language event depends from a second scripting language event when the respective events are in intrinsic temporal order.

8. The computer implemented method of claim 5, wherein the event information rule states that a first scripting language event depends from a second scripting language event when:
a timeout event for a timer is set or an AJAX request is triggered during execution of a handler script of the second scripting language event; and
the first scripting language event is the timeout event for the timer or the first scripting language event is an AJAX callback triggered by the timer or the AJAX request.

9. The computer-implemented method of claim 1, wherein determining whether an identified scripting language event depends on a preceding scripting language event comprises:
using a tag or a script property to explicitly specify that a first scripting event depends on a second script event;
using a tag or a script property to explicitly specify that a first scripting event is independent of other events; and/or
using an application programming interface (API) to allow parallel execution of a first script with one or more other scripts.

10. The computer-implemented method of claim 1, further comprising treating sequential execution of a group of scripts driven by events related to each other by dependency as a processing transaction, comprising;
determining, during an execution or after the execution of all the scripts, whether any script in the processing transaction has executed an invalid operation;
determining, after the execution of all the scripts, whether all the scripts have been validly executed;
committing the execution of the scripts and a result of the execution when the processing transaction is determined to be valid;
reversing the execution of the scripts and abandoning the result of the execution when the processing transaction is determined to be invalid; and
re-executing the processing transaction until the execution is determined to be valid.

11. The computer-implemented method of claim 10, wherein determining whether any script in the processing transaction has executed an invalid operation comprises:
logging a start-up time for each processing transaction;
identifying a shared resource;
logging and monitoring access and modification to the identified shared resource;
comparing the logged start-up time for each processing transaction that accesses a same shared resource; and
determining whether a particular processing transaction is invalid based at least in part on determining whether a script in that the processing transaction modifies a shared resource that is later accessed by a processing transaction with an earlier start-up time.

12. The computer-implemented method of claim 10, wherein reversing the execution of the scripts when the processing transaction is determined to be invalid comprises:
logging a state and a values of the identified shared resource before the identified shared resource is modified; and
restoring the state and the value of the identified shared resource after the identified shared resource is modified.

13. One or more computer-readable storage media storing computer-executable instructions that, when executed by a processor, perform acts comprising:
receiving a Web page file, the Web page file comprising tagged elements;
fragmenting the Web page file into tagged fragments;
determining, in parallel, whether each tagged fragment is a valid tagged element or an invalid tagged element;
merging the invalid tagged element to an immediately preceding tagged element;
parsing the individual tagged fragments in parallel;
merging the parsed results; and
rendering contents of the Web page file on a display device based at least in part on a document object model (DOM) tree.

14. The one or more computer-readable storage media of claim 13, wherein parsing the individual tagged fragments in parallel comprises:
iteratively serving, to an available thread, each individual tagged fragment to be parsed;
waiting for a thread to become available; and
continuing the iterative serving until each individual tagged fragment has been parsed.

15. The one or more computer-readable storage media of claim 14, further wherein merging the invalid tagged element comprises:
forming a merged DOM node;
submitting identified DOM nodes or merged DOM nodes to build the DOM tree sequentially; and
submitting a scripting event to a script engine based at least in part on whether the scripting event is an independent event or a dependent event.

16. A system comprising:
memory and one or more processors;
a Web page receiving module, stored in the memory and executable on the one or more processors, configured to receive a Web page file from a local cache memory or a network storage device accessible over a public or private network, the Web page file comprising tagged elements;
a scripting language event identifying module, stored in the memory and executable on the one or more processors, configured to identify independent scripting events and/or dependent scripting events from the tagged elements;
a sequential execution module, stored in the memory and executable on the one or more processors, configured to execute the dependent scripting event sequentially; and
a parallel execution module, stored in the memory and executable on the one or more processors, configured to execute the independent scripting events in parallel.

17. The system of claim 16, wherein executing the independent scripting events in parallel comprises dispatching items to be executed in parallel for running by different threads or processes.

18. The system of claim 16, further comprising:
a document object model (DOM) tree building module, stored in the memory and executable on the one or more processors, configured to build a DOM tree based at least in part on the executed scripting events; and
a rendering module, stored in the memory and executable on the one or more processors, configured to render contents of the Web page file on a display based at least in part on the DOM tree.

19. The system of claim 16, wherein executing the independent scripting events in parallel comprises:
creating event transactions, each event transaction comprising an independent scripting event or a chain of dependent scripting events that depend from each other;
iteratively assigning, to an available thread, each event transaction that comprises an independent scripting event to be executed;
waiting for a thread to become available; and
continuing the iterative assigning until each event transaction that comprises an independent scripting event has been executed

20. The system of claim 16, further comprising a validity determination module, stored in the memory and executable on the one or more processors, configured to determine whether each executed event transaction is valid, comprising:
logging a start-up time for each event transaction;
logging access to a global variable or a DOM object for each event transaction;
comparing the logged start-up times for event transactions that access a same global variable or a same DOM object; and
determining that a particular event transaction is invalid when the same global variable or DOM object is modified by the particular event transaction and is modified by another event transaction with an earlier start-up time.
